(19) United States
(12) Patent Application Publication
(10) Pub. No.: US 2013/0049383 A1
(43) Pub. Date: Feb. 28, 2013

(54) Apparatus to prevent removal of outward swing doors after removal of hinge pins and the method of installation

(71) Applicant: Martin A Sovis, Flushing, MI (US)

(72) Inventor: Martin A Sovis, Flushing, MI (US)

(21) Appl. No.: 13/594,736

(22) Filed: Aug. 24, 2012

Related U.S. Application Data
(63) Continuation of application No. 61/528,212, filed on Aug. 27, 2011.

(51) Int. Cl. E05C 19/00; B23P 11/00; E05D 11/00

(52) U.S. Cl. 292/300; 29/428

(57) ABSTRACT

The present invention is a restraining assembly which prevents a potential burglar from lifting an outward swing door from its respective doorframe after removing the exposed hinge pins. A female bushing is provided which is recessed into the hinge side door edge and expands to interlock within the door at the door edge as a male pin is fully engage within said female member. A head portion of the male member is left protruding and extending beyond the hinge side door edge allowing said protrusion to enter an opposing recess cavity in the adjoining doorframe upon the door being rotated to a closed position. Whereas one restraining assembly itself will prevent an outward swing door from being removed, it is understood that two or more assemblies may be utilized for added durability should a burglar exert a more vigorous force in an effort to pry out the door.

### CROSS-REFERENCE TO RELATED APPLICATION

This non-provisional application claims priority to Provisional Patent Application No. 61/528,212, filed on Aug. 27, 2011 by Martin Anthony Sovis, 5279 Duffield Road, Flushing, Mich. 48433-9786, the contents of which are hereby incorporated into this non-provisional application. Title of Provisional Application: APPARATUS TO PREVENT REMOVAL OF OUTWARD SWING DOORS AFTER REMOVAL OF HINGES OR HINGE PINS AND THE METHOD OF INSTALLATION.

### STATEMENT REGARDING FEDERALLY SPONSORED RESEARCH OR DEVELOPMENT

“not applicable”

### REFERENCE TO SEQUENCE LISTING, A TABLE, OR A COMPUTER PROGRAM LISTING COMPACT DISC APPENDIX

“not applicable”

### BACKGROUND OF THE INVENTION

The present invention relates generally but not specifically to doors that open outward from a building and are hollow or solid steel doors installed in hollow or solid steel frames commonly used in industrial buildings. Said doors normally by design have hinges exposed to the outside of the building to allow for the door to swing outward. More particularly the present invention apparatus consists of a male pin member secured to and projecting from an edge of a door and a receiving member within which the pin member seats when the door is rotated to the closed position, the receiving member being installed within a corresponding edge of the doorframe.

The purpose of the apparatus is to prevent unauthorized removal of an out-swing door after removing the hinge pins. A method of installing a restraining assembly according to the present invention is also disclosed and claimed which includes a blind hole transfer to accurately align the aperture drilled into the doorframe to the cavity required to be drilled into the door.

### DESCRIPTION OF THE PRIOR ART

Locking devices and assemblies that prevent door removal after hinge pins are removed are most often part of the hinge mechanism, or are a mechanical activated apparatus that requires specific attention by personnel.

U.S. Pat. No. 1,421,746 issued to Thorne teaches a similar apparatus but requires the corresponding door and frame to be mortised to allow for a lack of clearance between the door and frame. On steel doors and steel frames, mortising cannot be performed since a major reinforcement would be removed greatly diminishing the strength of the door and thus render said apparatus ineffective. In addition, the mating male and female parts are pre-mated by the manufacturer and as a result require critical measuring and added skill to install.

U.S. Pat. No. 2,571,633 issued to Vogel, U.S. Pat. No. 4,131,969 issued to Suska, and U.S. Pat. No. 4,135,273 issued to Holmes all directly teach interlocking segments within the hinge assembly itself requiring a change in hinges which normally do not meet the added strength of a steel door or cannot be installed in a steel frame. By design they also do not have enough projection to maintain an interlocking capability under a prying condition by vandals. Also the various dimensions of different hinges by competitive manufacturers make it impossible to change all hinges on the market.

U.S. Pat. No. 3,937,506 issued to Dean, teaches an interlocking tapered pin and cavity between the door and doorframe separate from the hinge assemblies, however are designed and will only work in a wooden door and doorframe.

U.S. Pat. No. 5,724,705 issued to Hauser teaches that cone shaped male and female members can be installed in the door edge and corresponding door frame. Whereas this application may have some credibility in wood doors and wood frames, it cannot be effectively installed into a hollow steel door and hollow steel frame.

U.S. Pat. No. 3,970,340 issued to Taft, and U.S. Pat. No. 5,769,473 issued to Sovis teach similar interlocking of components between those in a door edge and that in a door frame, but their purpose is to prevent dislodging of the hinges due to a weak door frame and surrounding structure normally made of a wood frame construction. By design this application is directed toward doors that swing in toward the inside of the building and the invention is to prevent doorframe destruction as an intruder applies force to break in the door.

The following U.S. Patents teach and refer to expansion anchor devices that are used for fastening an item through an aperture into a material that is solid such as cement. All utilize a tapered inner male member with a threaded hole in center of said male member that allows said male member to be drawn back toward the aperture hole entrance by means of a threaded screw, thus expanding an outer bushing in which said male member's taper is partially engaged into, allowing the bushing to expand against the aperture hole . The difference with these types of anchors is that all are secured by means of a threaded screw that draws the tapered male back toward the aperture hole opening. The point of contact for securing the device is only at the end of the device furthest from the entry aperture hole at which the taper expands the outer bushing. These will only work in a drilled or machined hole that forms a uniform cylindrical cavity in a material that is solid, since the expansion device may engage the newly formed cylinder at any location. Installing into a hollow cavity would not result in securing the device.

The prior art referenced are the following U.S. Patents:
U.S. Pat. No. 4,478,542 issued to Whelan
U.S. Pat. No. 6,579,049 issued to Kaibach
U.S. Pat. No. 4,789,282 issued to Abraham
U.S. Pat. No. 3,968,721 issued to Fischer
U.S. Pat. No. 5,401,131 issued to Yoshino
U.S. Pat. No. 4,772,166 issued to Shama et al
U.S. Pat. No. 4,789,284 issued to White
U.S. Pat. No. 4,519,735 issued to Machtle
U.S. Pat. No. 4,656,806 issued to Leibhard et al
U.S. Pat. No. 4,403,894 issued to Clark
U.S. Pat. No. 3,613,497 issued to Helderman
U.S. Pat. No. 4,678,383 issued to Bergner

The following U.S. Patents teach and refer to expansion anchor devices that are used for fastening an item through an aperture into a material that is thin or hollow beyond the aperture hole opening. All demand the female or cylindrical portion collapse creating a lock against the aperture body or drawing two or more aperture drilled layers together. This is accomplished by having the end cap section of the cylindrical portion threaded so that a threaded bolt or screw, contained by an oversize mechanism or washer at the aperture opening, allowing said bolt or screw to remain stationary and draw the end cap toward the aperture opening and collapse the cylindrical portion until it is tightened against the inside surface of the aperture body. These are all dependent on an open cavity beyond the surface of the aperture body and an acceptable thickness of material to allow for desired collapsing of the inner bushing.

The prior art referenced are the following U.S. Patents:
U.S. Pat. No. 3,316,379 issued to Clarke
U.S. Pat. No. 4,269,106 issued to Hilti Aktiengesellschaft
U.S. Pat. No. 4,416,572 issued to Black, assigned to Textron
U.S. Pat. No. 4,274,324 issued to Giannuzzi
U.S. Pat. No. 4,642,009 issued to Fischer
U.S. Pat. No. 5,259,714 issued to Campbell
U.S. Pat. No. 6,602,034 B2 issued to Wakai et al.
U.S. Pat. No. 7,901,171 B2 issued to Schruff

### BRIEF DESCRIPTION OF THE DRAWINGS

A better understanding of the present invention will be had upon reference to the attached drawings, when read in combination with the following specification, wherein like reference numerals refer to like parts throughout the several views, and in which:

FIG. 1 is a cross-sectional top view of a steel doorframe mounted to a standard industrial cinder block wall also showing a segment of a hollow steel door with the male portion member entering the steel doorframe through the female mating hole.

FIG. 2 is a cross-sectional view showing a blind hole transfer creating a center mark on the doorframe as the door is closed.

FIG. 3 is a blind hole transfer which is a purchase item used to transfer a center mark from the aperture in the door edge to the door frame to ensure exact alignment between the door and door frame.

FIG. 4 is a rear view of the female bushing showing the four slots that enable the bushing to expand and lock into a pre-drilled hole in a door edge.

FIG. 5 is a frontal view of the female bushing showing the incremental steps on the outside surface that allow for full locking within a pre-drilled door and various distances.

FIG. 6 is a cross-sectional frontal view of the female bushing showing the tapered inside dimension that engages the taper on the male portion during expansion.

FIG. 7 Is a side view of the male member showing the head portion, plus the tapered and lock portions that mate with the female bushing.

FIG. 8 is a perspective view of the male and female portions interlocked after assembly showing the female portion expanded due to the designed interference in both mating parts.

### DETAILED DESCRIPTION OF THE INVENTION

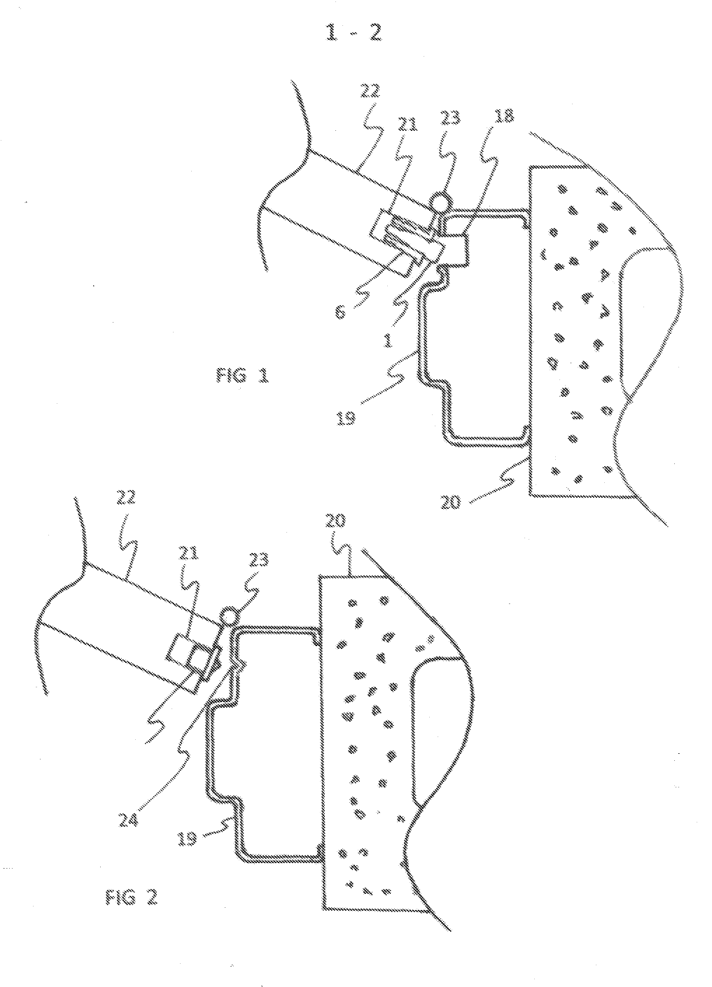

Referring now to FIG. 1, a restraining assembly is shown which is comprised of male pin 1 and female bushing 6 mounted within a door 22 hingedly connected to a doorframe 19 mounted within a standard cinder block wall 20. Though member 20 is shown as a standard cinder block wall it may be made of other materials including structural steel, wood frame, and such components commonly used in the building industry. Members 1 and 6 mounted within aperture 21 and thus installed in door 22 seats within member 18, which is a hole in said doorframe 19. The door 22 is shown in a closing position to illustrate the clearance needed as the two members 1 and 6 are married with hole 18. Upon final closure of door 22 and normal latching of a door latch or deadbolt, not shown in these drawings since they are not part of this invention, hinge member 23 could be removed and door 22 could not be removed from the surrounding doorframe 19 as would be possible without this invention. It is understood there are two or more hinge members 23, but are purposely not illustrated for clarity of this invention.

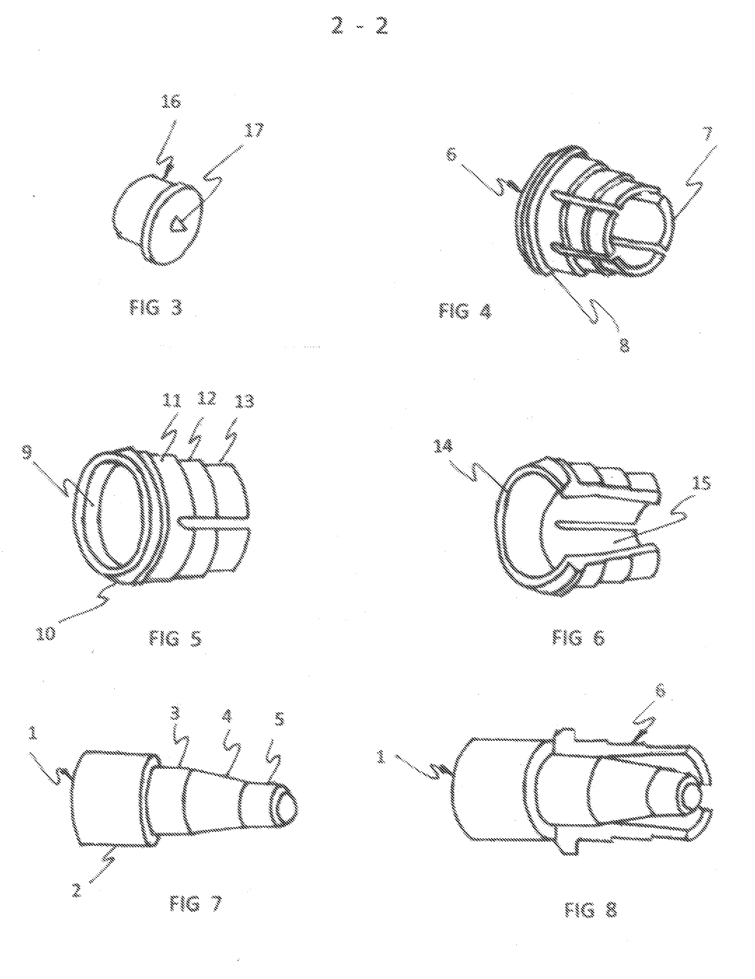

Referring now to FIGS. 1-8, a method for installing the restraining apparatus for use with a steel hollow door hingedly connected to a steel door frame will now be described. Referring specifically to FIG. 2 and to FIG. 3 and FIG. 5 an appropriate hole 21 is drilled into the edge of the door 22 on the hinge side centered between the outside face and inside face of door 22. The diameter of hole 21 is specific to the diameter 11 in FIG. 5 and to the purchased blind hole spotter 16 in FIG. 3. Specifically to FIG. 4 and FIG. 5, member 16 is then installed into the hole and door 22 is closed to allow member 17 to create a center mark 24 in doorframe 19 as door member 22 is closed. Door 22 is then opened and member 16 is removed and does not remain part of the restraining apparatus. Referring now to FIG. 1, at center mark 24 the appropriate size hole 18 is drilled into doorframe 19 and a protective cavity plug may or may not be installed for protection against a potential burr resulting from drilling. It is understood the cavity plug may be considered a cosmetic purpose. Referring now to FIG. 8 and referencing FIG. 4 through FIG. 7, the female member 6 is installed into hole 21 in the edge of door 22 ensuring that edge 8 seats against the edge of the door at aperture 21. Taper 10 of member 6 reduces the diameter 8 to the diameter 2 of member 1 to allow for any mis-alignment in the drilling process. Once in place, member 1 is now inserted into member 6 which is seated securely into hole member 21. Member 5 will enter hole member 6 until taper 4 on the outside of male member 1 matches the inside taper 15 in member 6. At this point a hammer, or suitable device is used to drive member 1 further into member 6 forcing segments 7 to expand axially creating an interference with and locking into hole 21. Member 1 is driven into member 6 with member diameter 3 having a slight clearance to member diameter 9. Member 1 is driven until the shoulder of diameter 2 is against the face member 14. Referring specifically to FIG. 8, when member 1 is seated properly, it will force members 11, 12, or 13 to lock against the hole member 21 drilled into the edge of door member 22.

It is understood that additional mating members 1 and 6, and hole member 21 along with corresponding hole 18 in frame 19 can be installed in a second position on an entrance door, however for clarity, this description covers only one installation.

The present invention therefore discloses a restraining assembly apparatus in which the mating components prevent removal of an outward swing door should the hinges of the door be removed for unauthorized entry and can be installed with minimum alignment and drilling

Having described my invention, additional embodiments will become apparent to those skilled in the art to which it pertains without deviating from the scope of the appended claims.

I claim:

1. A restraining assembly comprised of a male pin member and female member for use and installed in a steel type door hingedly connected to a surrounding doorframe, the door having a hinge side and a latch side where the connected door generally swings outward of the building and the doorframe generally being of a steel or similar strength composite. At least one assembly interlocked into said door with a portion of the male axially projecting laterally from the door edge in a direction toward the associated doorframe and extending into a seating portion in the doorframe.

2. The method of installation by which a hole drilled into the door edge accepts a blind hole transfer punch for the purpose of closing the door and creating a centermark on the associated doorframe. The punch being then removed allows for the female portion member to be placed into the hole, the female member then accepting the male pin member and by means of a force generated on the male pin interlocks the male and female members with the door edge. Moving to the associated doorframe, the centermark is used to position an appropriate hole to accept a protruding male pin head as the door is closed. The protruding section of said portion assembly seats into a perfectly aligned hole in the doorframe. Said restraining assembly is adapted to incorporate the door and doorframe into a single unit to prevent removal of the door from its associated doorframe when the hinge pins are removed from the door and doorframe assembly without restricting the door being opened in a conventional manner by which the door swings on the hinges that attach the door to the doorframe. It is understood that two restraining assemblies would preferably be installed on one door to ensure a more robust interlock of the door and doorframe.

3. The configuration of the male portion pin and its ability to react with the female member by which the lead small diameter allows for a fast alignment, the conical taper interacts with the female portion during expansion, and the linear cylindrical surface that follows the conical taper, along with the shoulder of the head diameter which allows for exact positioning of the male pin when locked into the female bushing allowing for an exact projection to interact with the corresponding female receptacle in the associated doorframe as the door is closed into said door frame.

4. The configuration of the female portion member having a stepped outside diameter that fits into the hole drilled into the door edge and its associated inner taper that allows for the outside diameter to lock against the inside of said door no matter where a resistance occurs when the male portion is driven into the female portion.

5. A fast installation with the ability of the male pin to be driven into the female bushing with a single blow of a hammer or similar object and still creating the proper male position of the male projectile for interaction with the female receptacle in the associated doorframe.

6. The restraining assembly will commonly be molded or cast from a composite steel but can also be machined and can also be made of a material including composite plastic or the like with a suitable strength realizing the purpose is to interlock the door to the doorframe and prevent lifting out the door after the hinge pins have been removed by means of the interaction with the associated doorframe.
